(19) United States
(12) Patent Application Publication
(10) Pub. No.: US 2021/0194391 A1
(43) Pub. Date: Jun. 24, 2021

(54) POWER GENERATING APPARATUS

(71) Applicant: Haruo ORIHASHI, Higashihiroshima-shi (JP)

(72) Inventors: Haruo ORIHASHI, Higashihiroshima-shi (JP); Kenji ORIHASHI, Higashihiroshima-shi (JP); Yuriko ORIHASHI, Higashihiroshima-shi (JP); Fumiharu ORIHASHI, FUJIMI-SHI (JP); Hiroko TAKEHIRO, Hiroshima-shi (JP)

(21) Appl. No.: 17/119,588

(22) Filed: Dec. 11, 2020

(30) Foreign Application Priority Data
Dec. 24, 2019 (JP) 2019-232953

(51) Int. Cl. H02N 15/04; H01F 6/06; H01F 6/04

(52) U.S. Cl. CPC H02N 15/04; H01F 6/04; H01F 6/06

(57) ABSTRACT

A power generating apparatus for obtaining a force to repulse the gravitational force includes a columnar magnet, generating a magnetic field, and an electromagnetic wave irradiation part, irradiating an electromagnetic wave on a gravitational wave in parallel or substantially in parallel with a gravitational wave within the magnetic field, having been generated, thereby a power which is repulsive to the gravitational force is generated.

### BACKGROUND OF THE INVENTION

### Field of the Invention

The present invention relates to a power generating apparatus for obtaining a force to repulse the gravitational force.

### Description of the Related Art

Conventionally, there have been proposed a number of such apparatuses as flying bodies loaded with an engine for propelling themselves vertically or horizontally in a 3-D space, rockets, which injects the fuel downward for obtaining a propelling force (motive power), and submarines, which utilize rotation of a screw as a propelling force for moving themselves in water. Such propelling forces provide motive power for moving mobile bodies, and they have been obtained by using gasoline, a solid fuel, or the like.

In addition, there has been another proposal, in which, within a magnetic field, supplied hydrogen is caused to emit electrons at one gas diffusion electrode (the fuel electrode) to produce hydrogen ions, which are then moved to the other gas diffusion electrode (the air electrode) in sea water, being an electrolytic solution, to generate electric energy, and an electric current is caused to flow between both electrodes to thereby move the sea water on the basis of Fleming's left-hand rule for obtaining a propelling force through the utilization of a reaction force of the sea water (refer to second to fourth pages and FIG. 1 in Patent Document 1, for example).

Patent Document 1: Japanese Unexamined Patent Application Publication No. 1998-297589

However, any of the above-mentioned conventional technologies for obtaining a propelling force consumes a large quantity of energy, and cannot always be said to be preferable from the viewpoint of ecology on a global scale, and the like. In addition, fossil fuels are running out year by year.

In addition, the apparatus as disclosed in Patent Document 1 have disadvantages that it requires such components as chambers for accommodating gases, such as hydrogen gas, thereby the scale of the apparatus being increased, and hydrogen gas must be handled with great care due to its combustibility, and the like.

The present invention has been made in view of the above-mentioned problems that are associated with the conventional technologies, and is intended to provide a power generating apparatus for obtaining a force to repulse the gravitational force.

### SUMMARY OF THE INVENTION

In order to achieve the above purpose, the power generating apparatus of the present invention includes:
a magnetic field generation part, generating a magnetic field, and
an electromagnetic wave irradiation part, irradiating an electromagnetic wave on a gravitational wave within the magnetic field, having been generated.

Herein, it is preferable that the electromagnetic wave irradiation part irradiate the electromagnetic wave in parallel or substantially in parallel with the gravitational wave at the center or in a vicinity of the center of the magnetic field, having been generated by the magnetic field generation part.

In addition, the magnetic field generation part can be configured such that it generates a magnetic field when an electric current is caused to flow through a coil, being formed by winding an electric wire around a non-magnetic material cylindrical member, or can be configured such that it is formed of a cylindrical magnet.

Further, the magnetic field generation part can be configured such that it causes an electric current to generate a magnetic field after the coil having been brought into a superconducting state.

With the power generating apparatus according to the present invention, a force repulsive to the gravitational force can be obtained. In addition, it is capable of realizing a mobile body that is moved with a force repulsive to the gravitational force.

### BRIEF DESCRIPTION OF THE DRAWINGS

FIG. 1 is a configuration drawing schematically exemplifying a power generating apparatus;

FIG. 2 is a configuration drawing schematically exemplifying a power part of the power generating apparatus;

FIG. 3 is a configuration drawing exemplifying a mobile body, being equipped with the power generating apparatus;

FIG. 4 is a configuration drawing exemplifying a mobile body in another embodiment;

FIG. 5 is a configuration drawing exemplifying a balance, having been used for measurement;

FIG. 6 is an explanation drawing exemplifying a measuring instrument with an electromagnetic coil;

FIG. 7 is an explanation diagram exemplifying a configuration of a part of an electrical system;

FIG. 8 is an explanation diagram exemplifying a configuration of a part of an electrical system;

FIG. 9 is an explanation drawing exemplifying a measuring instrument with magnets;

FIG. 10 is an explanation drawing exemplifying another measuring instrument with magnets;

FIG. 11 is an explanation drawing for a hypothesis;

FIG. 12 is a configuration drawing schematically exemplifying a variant of the power generating apparatus; and

FIG. 13 is a configuration drawing schematically exemplifying another variant of the power generating apparatus.

### DETAILED DESCRIPTION OF THE PREFERRED EMBODIMENTS

Hereinbelow, embodiments representing the present invention will be explained with reference to the drawings. However, the embodiments, being explained hereinafter, are one example, and the present invention is not limited to these embodiments.

<Setting of Hypotheses>

At present, since the real identity of gravitational wave itself has not been clarified, the present invention sets the following two hypotheses to configure a power generating apparatus 10 for repelling the universal gravitation. In other words, the hypothesis 1 assumes that “the gravitational wave is an electromagnetic wave”, and the hypothesis 2 assumes that “the gravitational wave is based on the structure of “proton” and “neutron”.

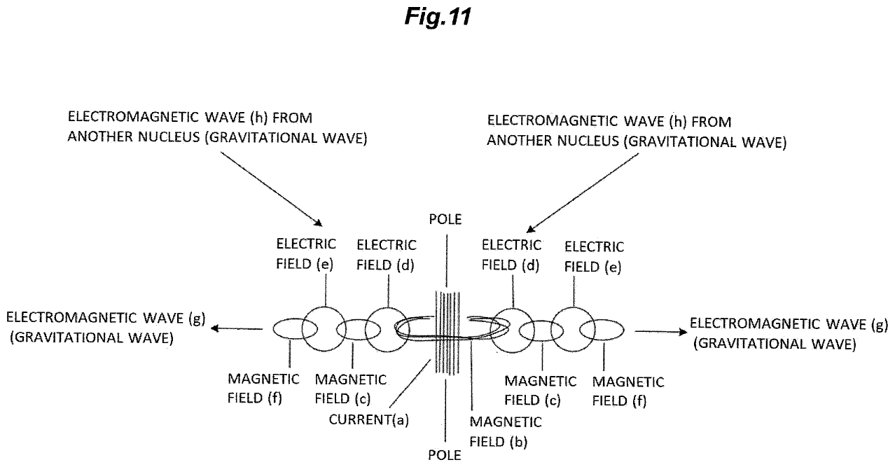

FIG. 11 is an explanation drawing for these two hypotheses. The structure of a “proton” or a “neutron”, constituting an atomic nucleus, is as shown in FIG. 11. In other words, at the center of a “proton” or a “neutron”, there is a spot where an electric current (a) is heavily oscillated vertically. In accordance with the oscillation of the electric current (a), a magnetic field (b) is generated outside of the electric current (a). Actually, with the electric current (a) being moved, a magnetic field (b) is generated, the magnetic field (b) regenerating an electric current (a), and further, a magnetic field (b) being generated to regenerate an electric current (a). In this way, in the inside of a “proton” or a “neutron”, an electric current is repetitively produced.

Fundamentally, if the space is a free space, existence of an electric current (a) generates a magnetic field (b), and with such a thing being repeated, an electric field (d), a magnetic field (c), an electric field (e), and a magnetic field (f) are generated, thereby an electromagnetic wave being delivered, however, the inside of a “proton” or a “neutron” provides an extremely narrow space, compared to the free space, and thus only the generation of an electric current (a) and a magnetic field (b) will be repeated.

In addition, around the magnetic field (b), a number of electric fields (d) are generated, but the electric fields (d) repulse one another, thereby the intensity of the resulting electric field (d) is extremely low. Accordingly, the electromagnetic wave (g), which is delivered as a combined wave of the electric field (d), and the magnetic, field (c), the electric field (e), and the magnetic field (f), following the electric field (d), has an extremely low intensity. Such electromagnetic wave (g) acts as a “gravitational wave”.

If a “proton” or a “neutron” in such a state is subjected to an electromagnetic wave (h) from the outside, the “proton” or the “neutron” will be excited to thereby obtain a longer life. Whether the region of the “proton” or the “neutron” covers only the electric current (a) and the magnetic field (b), or it also covers the electric field (d) and the magnetic field (c), or further the electric field (e) and the magnetic field (f) is unclear with the above-mentioned hypotheses.

<Configuration of Power Generating Apparatus 10>

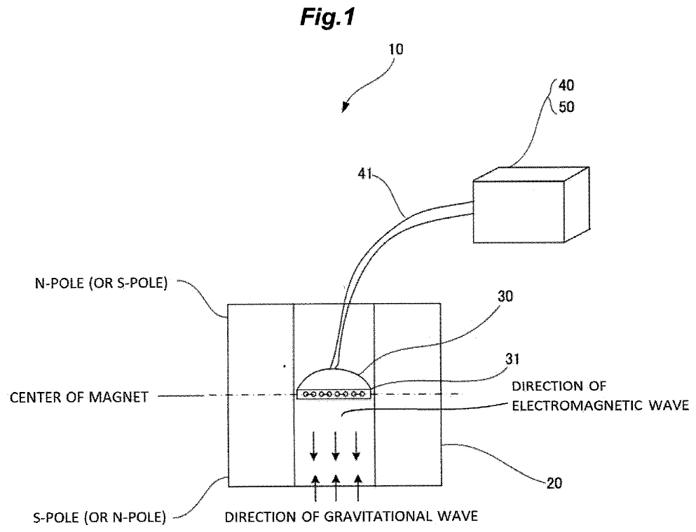

FIG. 1 is a configuration drawing for the power generating apparatus 10. The power generating apparatus 10 has a columnar magnet 20, an electromagnetic wave irradiation device 30, an electromagnetic wave irradiation part 31, an electromagnetic wave irradiation device power supply 40 and controller 50, and an electromagnetic wave irradiation device wiring 41. In the present embodiment, the columnar magnet 20 corresponds to one example of the “magnetic field generation part” of the present invention, the electromagnetic wave irradiation part 31 corresponds to one example of the “electromagnetic wave irradiation part” of the present invention.

The columnar magnet 20 is, for example, a cylindrical magnet, being hollow as a whole, with the upper half providing an N-pole (or an S-pole), while the lower half an S-pole (or an N-pole). In addition, at a middle location in a vertical direction of a hollow part of the columnar magnet 20, the electromagnetic wave irradiation part 31 of the electromagnetic wave irradiation device 30 is disposed.

The electromagnetic wave irradiation device 30 is connected to the electromagnetic wave irradiation device power supply 40 and controller 50 by means of the electromagnetic wave irradiation device wiring 41. In addition, from the electromagnetic wave irradiation part 31, an electromagnetic wave is irradiated in parallel or substantially in parallel with a magnetic field, being generated by the columnar magnet 20, and the electromagnetic wave irradiation part 31 is subjected to a gravitational wave. In FIG. 1, the generation of a magnetic field using the columnar magnet 20 as one example is explained, however, if the magnetic field generated is in parallel or substantially parallel with the gravitational wave, either of the N magnetic field and the S magnetic field may be used.

Electromagnetic waves to be irradiated from the electromagnetic wave irradiation device 30 include electric waves (electromagnetic waves for communications, observation, and the like), far-infrared rays, visible light rays, ultraviolet rays, X-rays, gamma rays, and various laser rays. In the later-described Example, an ultraviolet ray is used as one example of electromagnetic wave.

<Operating Principle of Power Generating Apparatus 10>

The hypothesis 1, having been set above, assumes that the “gravitational wave” is an electromagnetic wave. When an electromagnetic wave, being, irradiated from the electromagnetic wave irradiation part 31 as an artificially prepared wave, is collided with a gravitational wave (an electromagnetic wave) within the magnetic field of either the N-pole or the S-pole in the columnar magnet 20, the respective electromagnetic waves are deformed into the same shape of wave by the magnetic field.

Herein, the statement of “are deformed into the same shape of wave” means that both of the gravitational wave and the electromagnetic wave, which has been irradiated from the electromagnetic wave irradiation part 31, are transformed into the same oscillation mode of wave. In the state in which both the gravitational wave and the electromagnetic wave have been transformed into the same oscillation mode of wave, a repulsive force is generated between both waves. Herein, the action of transformation supports the hypothesis of “the gravitational wave is an electromagnetic force”, which is given above under the heading of “Setting of hypotheses”. Further, with an electromagnetic wave, there exist the N magnetic field and the S magnetic field in an alternative manner.

From these, it can be considered that both of the gravitational wave and the electromagnetic wave, which has been irradiated from the electromagnetic wave irradiation part 31, are of the same oscillation mode, although they are different from each other in oscillation frequency. When those electromagnetic waves having the same oscillation mode are each passed through the S-pole in FIG. 1, the S waveform of the electromagnetic wave is reduced, being subjected to a repulsive force of the S magnetic field of the magnet. The N waveform of the electromagnetic wave is enlarged, being provided with an attractive force of the S magnetic field of the magnet. With both the enlarged N waveform of the gravitational wave and that of the electromagnetic wave being collided with each other, a repulsive force is produced. In case where there is given no magnetic field of a magnet, since the S waveform and the N waveform of an electromagnetic wave are of the same oscillation mode, either repulsion or attraction will not be caused.

### Embodiment 1

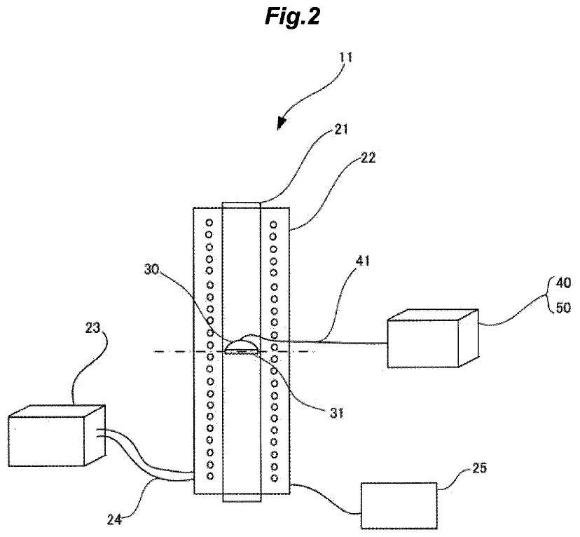

FIG. 2 is a configuration drawing of a power part 11 as another form of power part in the power generating apparatus 10. In the power part 11, a coil is wound around the outer periphery of a non-magnetic material cylinder 21, being made of a non-magnetic material, to thereby provide a superconducting coil unit 22. Both ends of the coil are connected to a superconducting coil power supply 23 by means of a superconducting coil wiring 24. The coil is brought into a superconducting state with a superconducting coil cooling device 25.

The electromagnetic wave irradiation device power supply 40 and controller 50 is connected to the electromagnetic wave irradiation device 30 by means of an electromagnetic wave irradiation device wiring 41. The electromagnetic wave irradiation device 30 is disposed at an intermediate location in the vertical direction in the inside of the non-magnetic material cylinder 21 in order to place it in the central portion of the magnetic field. The present embodiment is characterized in that, in order to provide a stronger magnet, the “magnetic field generation part” of the present invention is constituted by the superconducting coil unit 22.

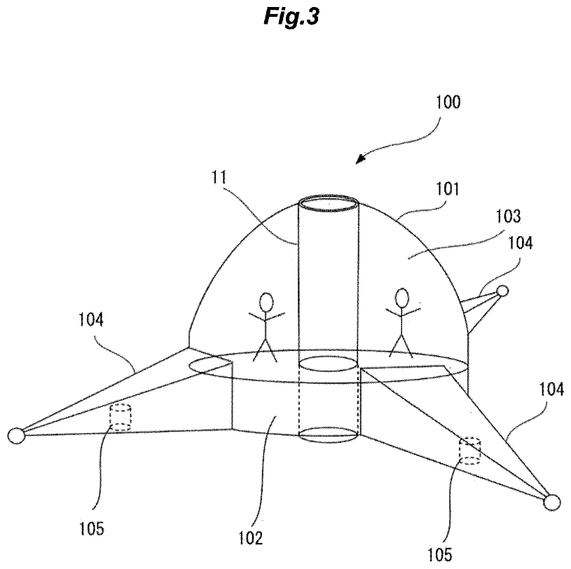

FIG. 3 is a configuration drawing of a mobile body 100, being equipped with the power part 11 (i.e., power generating apparatus) shown in FIG. 2. The mobile body 100 shown in FIG. 3 is provided with the power part 11 in the central portion of a dome-shaped airframe 101. In the lower portion of the airframe 101, there is provided a machine room 102. In the machine room 102, fuel, a power supply, an airframe controlling part, various types of controlling devices, and the like, are provided, for example. Further, in the upper portion of the machine room 102, there is provided a crew residence space 103.

The airframe 101 is provided with three arms 104, which are arranged at equal angles in a plain view. In the respective arms 104, an airframe posture controlling part 105 is provided. The airframe posture controlling part 105 is comprised of, for example, a small-sized propulsion device, being capable of controlling the posture, a wheel, and the like.

The power part 11 (i.e., the power generating apparatus) generates power high enough to repulse the gravitational wave to lift the airframe 101. When the electromagnetic wave irradiation device in the power part 11 (see FIG. 2) is oriented to the top of the airframe 101, the lower side of the airframe 101 is provided as a repulsing side of the airframe 101 to allow it to be moved upward. Herein, the gravitational wave not always arrives at from a definite direction, and thus the mobile body 100 is configured such that, by controlling the power part 11 and the airframe posture controlling part 105, the power can be generated in a desired direction to move the airframe 101 in that direction.

<<Operation of Mobile Body 100>>

With the superconducting coil cooling device 25, being provided in the machine room 102 (see FIG. 2, the superconducting coil unit 22 (see FIG. 2) is cooled. Thereafter, by energizing the superconducting coil unit 22, a powerful magnetic field is obtained. With the electromagnetic wave irradiation device power supply 40 and controller 50 (see FIG. 2), an electromagnetic wave is irradiated from the electromagnetic wave irradiation device 30 (see FIG. 2). Thereby, the power part 11 functions to generate power. Through the operation of the airframe posture controlling part 105 and the electromagnetic wave irradiation device power supply 40 and controller 50 (see FIG. 2), the airframe 101 is lifted and propelled.

### Embodiment 2

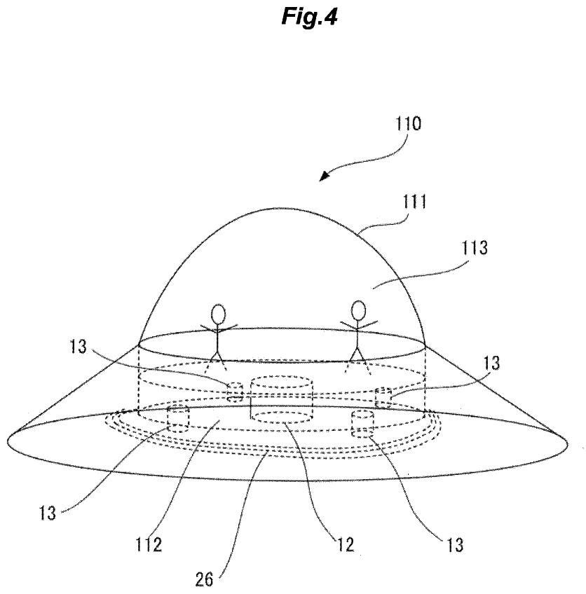

FIG. 4 is a configuration drawing of a mobile body 110 in Embodiment 2. With the mobile body 110 shown in FIG. 4, there is disposed another form of power part in a machine room 112 in the lower portion of a dome-shaped airframe 111. In the above-described Embodiment 1, power is generated only by the power part 11, however, the present Embodiment 2 is characterized in that, as power part, there are provided amain power part 12 and a sub-power part 13. In FIG. 4, for example, four sub-power parts 13 are provided, a single superconducting coil 26 being provided in correspondence with these four sub-power parts 13.

With this form of power part, a plurality of sub-power parts 13 are provided, the magnetic field being generated by the superconducting coil 26, whereby more powerful motive power can be generated. Moreover, a single superconducting coil 26 is provided for a plurality of sub-power parts 13, thereby the total weight being reduced. Needless to say, the mobile body 110 may be configured such that each sub-power part 13 is provided with a superconducting coil 26.

Herein, the gravitational wave arrives at not only from a single direction, but also from every direction, and therefore, on the earth, it is felt that the gravitational wave arrives at from one's feet, however, actually, a composite of the “gravitational waves”, having arrived at from every direction, is felt as the force of gravity in the vertical direction. In other words, if the airframe 111 is on the earth, it is subjected to the gravitational wave from every direction thereunder. Then, by receiving the gravitational wave from every direction under the airframe 111 with a wide area to irradiate an electromagnetic wave over a wide area, higher power can be obtained. The airframe 111 can be configured such that the direction of propulsion can be controlled through the control of the main power part 12 and the sub-power parts 13.

### EXAMPLE

<Details of Experiment and Measurement>

Next, the details of the experiment and measurement that have provided a ground for the present invention will be explained.

<<Structure of Balance 200, Which Was Used for Measurement>>

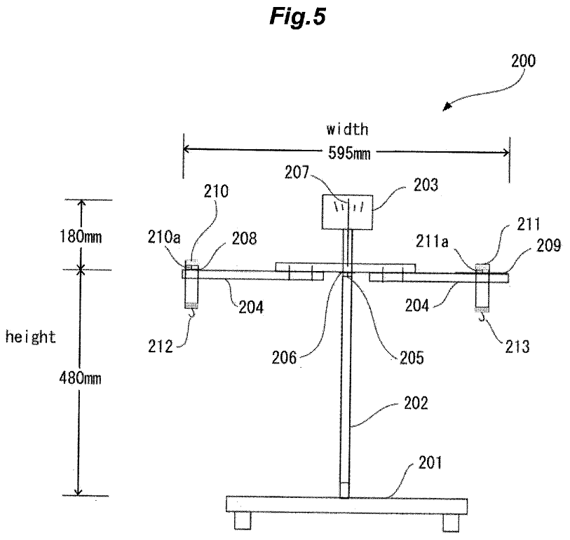

FIG. 5 is a configuration drawing of a balance 200, which was used for measurement. With the balance 200, a post 202 is provided to stand on a base 201, and at the upper end of the post 202, a scale plate 203, being graduated, is fixed.

In addition, in a portion above the middle of the post 202, there is provided a balance arm receiving blade 205, serving as a fulcrum for the right and left weights of a balance arm 204. In this way, the balance arm 204 is formed symmetric. In the central portion in a longitudinal direction of the balance arm 204, there are provided a supporting plate 206, being made of metal, for supporting the balance arm receiving blade 205, and a pointer 207. The balance arm 204 is formed of a square timber.

At one end of the balance arm 204 (the left end in FIG. 5), there is provided a receiving plate 208 for a supporting blade 210a, being given in a measuring instrument suspension part 210, being made of metal. In addition, at the other end of the balance arm 204 (the right end in FIG. 5), there is provided a receiving sliding plate 209 for a supporting blade 211a, being given in a weight suspension part 211, being made of metal. The measuring instrument suspension part 210 is provided at one end of the balance arm 204, while the weight suspension part 211 is provided at the other end of the balance arm 204.

In the measuring instrument suspension part 210, the supporting blade 210a therefor is provided, and also in the weight suspension part 211, the supporting blade 211a therefor is provided. The supporting blade 210a for the measuring instrument suspension part 210 is set on the receiving plate 208. On the other hand, the supporting blade 211a for the weight suspension part 211 is set on the receiving sliding plate 209. Further, the edge of the supporting blade 210a for the measuring instrument suspension part 210, and that of the supporting blade 211a for the weight suspension part 211 serve as a fulcrum for the measuring instrument suspension part 210 and the weight suspension part 211, respectively.

The position of the measuring instrument suspension part 210 is fixed. The weight suspension part 211 has a structure, allowing it to be moved on a receiving sliding plate 209, thus being configured so as to allow adjustment of the balance with the weight of a measuring instrument. With the balance arm 204, there are marked graduations by dividing the length, ranging from the central point thereof to the location where the supporting blade 210a for the measuring instrument suspension part 210 is fixed, into ten equal parts, for example. The graduations serve to roughly know the loss in weight of a coin, the weight thereof being previously known, that will be produced as a result of repulsion against the gravitational force by the coin at the time of measurement.

Further, in the lower portion of the balance arm 204 at one end thereof, there is provided a hanging metal fitting 212 for suspending a measuring instrument therefrom, while, in the lower.portion of the balance arm 204 at the other end thereof, there is provided a hanging metal fitting 213 for suspending a weight therefrom. The balance 200, which was used, was specifically 595 mm wide and 660 mm high.

<<Operation of Balance 200>>

First, the measuring instrument is suspended from the hanging metal fitting 212. Then, the weight is suspended from the hanging metal fitting 213. The weight suspension part 211 is moved to strike a balance with the measuring instrument. Balancing is performed in such a way that the pointer 207 is stopped at the center of the graduations of the scale plate 203. Herein, for easier balancing, a coin is placed on the balance arm 204 before sliding the weight suspension part 211 in the extending direction of the balance arm 204. At this time, if the coin is placed at the center of the graduations, it is convenient to obtain a rough estimate of the “loss in weight” that will be caused at the time of measurement. Once a balance has been struck, the measuring instrument is energized for making a measurement operation.

<<Measuring Instrument 300 with Electromagnetic Coil>>

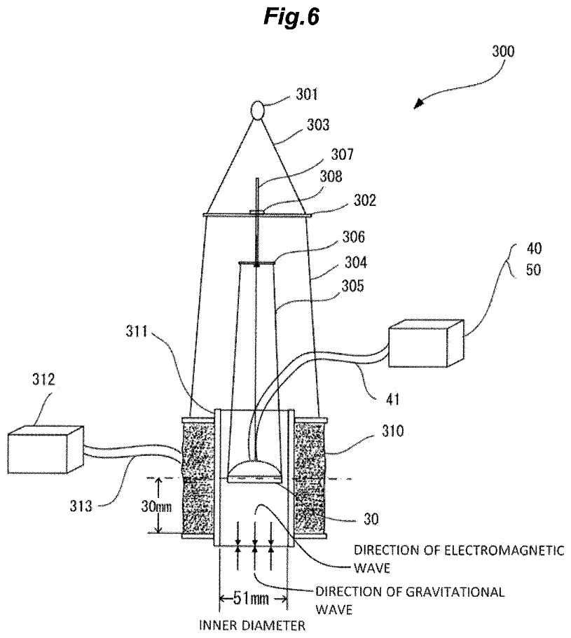

FIG. 6 is an explanation drawing for a measuring instrument 300 with an electromagnetic coil. The measuring instrument 300 is provided with a suspending ring 301 at the upper end thereof for suspending it from the hanging metal fitting 212 for the measuring instrument (see FIG. 5), and from the suspending ring 301, an electromagnet suspending plate 302 is suspended by means of three suspending strings 303. From the electromagnet suspending plate 302, an electromagnetic coil 310 is suspended with the use of three suspending strings 304. Herein, the electromagnetic coil 310 is disposed substantially horizontally such that the axis thereof is positioned vertically.

The electromagnetic coil 310 is formed by winding an electric wire around a flanged cylinder 311, being made of a non-magnetic material, by a desired number of turns. Both ends of the electromagnetic coil 310 are connected to an electromagnetic coil power supply 312 through an electromagnetic coil wiring 313.

The electromagnetic wave irradiation device 30 is suspended from an electromagnetic wave irradiation device suspending plate 306 by means of three suspending strings 305. At the center of the electromagnetic wave irradiation device suspending plate 306, a position adjusting screw 307 having a prescribed length (60 mm) is provided to stand. The position adjusting screw 307 is passed through the center of the electromagnet suspending plate 302, being screwed with a position adjusting nut 308, being provided at the center of the same.

By adjusting the tightening position of the position adjusting nut 308, the positional relationship in a vertical direction between the electromagnetic coil 310 and the electromagnetic wave irradiation device 30 can be adjusted. In addition, the electromagnetic wave irradiation device 30 is connected to the electromagnetic wave irradiation device power supply 40 and controller 50 by the electromagnetic wave irradiation device wiring 41, whereby the intensity, and the like, of the electromagnetic wave, being irradiated from the electromagnetic wave irradiation device 30, can be operation-controlled.

Next, the main components of the measuring instrument 300 will be explained in detail. In FIG. 6, the flanged cylinder 311, being made of a non-magnetic material, is manufactured specifically from a plywood of 3 mm in thickness, the cylinder inside diameter being 51 mm, and the winding width being 60 mm. The electromagnetic coil 310 is formed by winding an enameled electric wire of 0.8 mm in diameter around the flanged cylinder 311, being made of a non-magnetic material, by 1300 turns.

The electromagnetic coil 310 has a winding width of 60 mm, and thus the central portion of the magnetic field is provided at a location 30 mm above the lower end of the flanged cylinder 311, made of a non-magnetic material, where the electromagnetic wave irradiation device 30 is disposed. In addition, the electromagnetic coil wiring 313 is an electric wire, being prepared by peeling off a coating of an IV electric wire having a thickness of 0.5 sq, and annealing it. Herein, the “sq” is an index for indicating the thickness of a wire, which is defined by JIS.

The electromagnetic wave irradiation device 30 is specifically a 32-lamp type black light, emitting ultraviolet light. This 32-lamp type black light is operated with three size-D batteries, being connected in series. By turning on or off a switch, being provided for the electromagnetic wave irradiation device power supply 40 and controller 50, the 32-lamp type black light is lighted or extinguished.

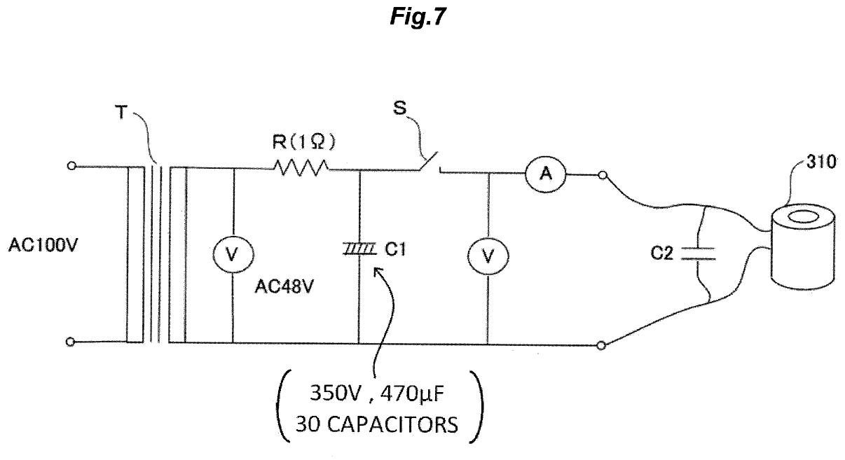

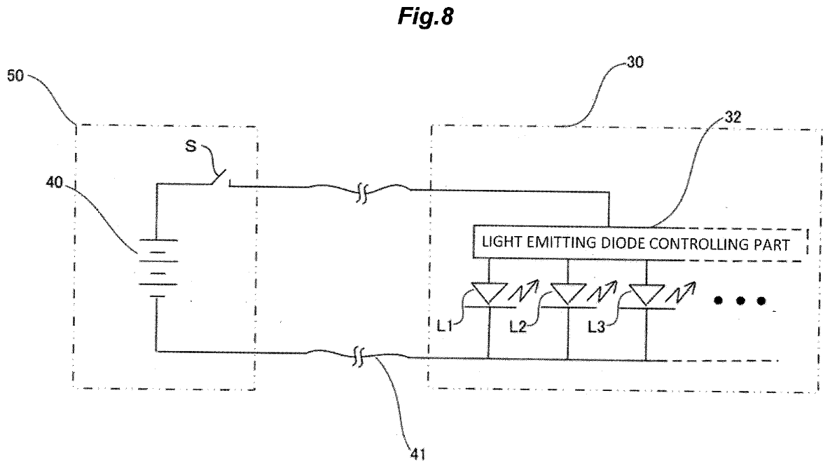

FIG. 7 and FIG. 8 are diagrams showing a part of the electrical system. FIG. 7 shows the electrical connection between the electromagnetic coil power supply 312 and the electromagnetic coil 310. In FIG. 7, a transformer T transforms a voltage of 100V AC into a voltage of 48V AC. On the secondary side of the transformer T, a resistor R having a resistance of 1 ohm is connected in series, and a capacitor C1 is connected in parallel. The capacitor C1 is composed by connecting 30 capacitors having a capacitance of 470 μF in parallel with one another.

To the right end of the resister R, a switch S is connected. To the switch S, one end of the electromagnetic coil 310 is connected through an ammeter A. The other end of the electromagnetic coil 310 is connected to the secondary side of the transformer T. In addition, to the electromagnetic coil 310, a capacitor C2 is connected in parallel, and a voltmeter V is connected in parallel. Through the on-off operation of the switch S, whether or not an electric current is to be caused to flow through the electromagnetic coil 310 can be selected. As one example, when a DC voltage of 48.5 V was applied, an electric current of 3.3 A was measured.

FIG. 8 is a diagram showing the electrical connection between the electromagnetic wave irradiation device power supply 40 and controller 50 and the electromagnetic wave irradiation device 30. The electromagnetic wave irradiation device power supply 40 and controller 50, and the electromagnetic wave irradiation device 30 are mutually connected by the electromagnetic wave irradiation device wiring 41. As the electromagnetic wave irradiation device power wiring 41, an electric wire with very small diameter for communications is used. The controller 50 is provided with a switch S. By operating this switch S, the controller 50 can control supply of an electric current from the electromagnetic wave irradiation device power supply 40, which is a DC power supply.

In addition, the electromagnetic wave irradiation device 30 has aplurality of LEDs (L1, L2, L3, and . . . ), irradiating ultraviolet light, as the electromagnetic wave irradiation part 31, and alight emitting diode controlling part 32 for lighting control of these diodes. When the switch S is turned on, the light emitting diode controlling part 32 lights all the LEDs (L1, L2, L3, and . . . ) by means of its LED driving function. As a result of this, ultraviolet light is irradiated as an electromagnetic wave in parallel or substantially in parallel with the gravitational wave.

<<Measuring Instruments 300A and 300B with Magnets>>

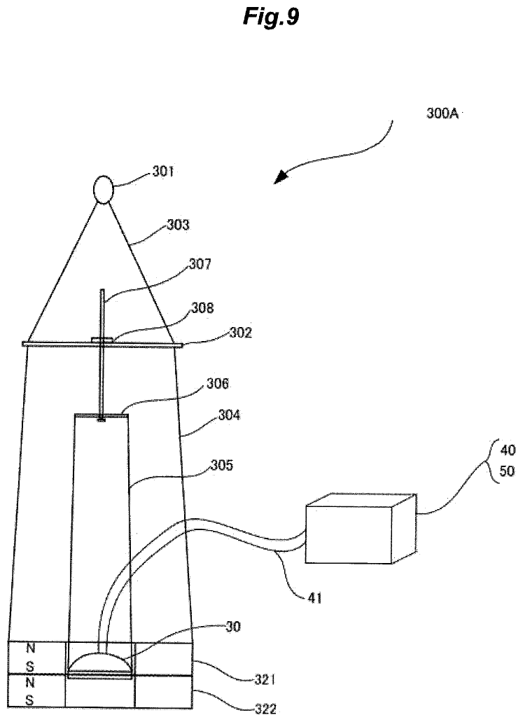

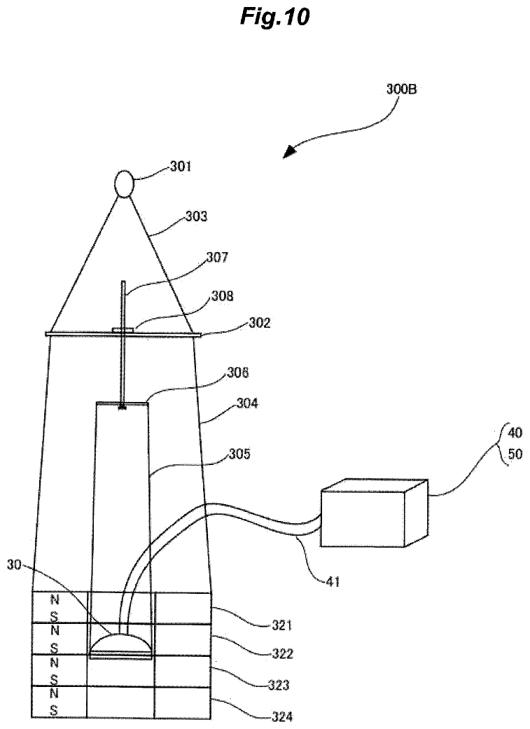

FIG. 9 and FIG. 10 are explanation drawings of measuring instruments 300A and 300B with magnets, respectively. The measuring instrument 300A in FIG. 9 is provided with a suspending ring 301 at the upper end thereof for suspending it from the hanging metal fitting 212 of the balance 200 (see FIG. 5), and from the suspending ring 301, a magnet suspending plate 302 is suspended by means of three suspending strings 303. From the magnet suspending plate 302, two ring-shaped magnets 321 and 322 are suspended with the use of three suspending strings 304. Herein, the two ring-shaped magnets 321 and 322 are disposed one upon another substantially horizontally such that the respective axes thereof are positioned vertically.

In addition, as with the measuring instrument 300 shown in FIG. 6, the electromagnetic wave irradiation device 30 is suspended from an electromagnetic wave irradiation device suspending plate 306 with the use of three suspending strings 305: At the center of the electromagnetic wave irradiation device suspending plate 306, a position adjusting screw 307 having a prescribed length (60 mm) is provided to stand. The position adjusting screw 307 is passed through the center of the magnet suspending plate 302, being screwed with a position adjusting nut 308, being provided at the center of the same.

By adjusting the tightening position of the position adjusting nut 308, the positional relationship in a vertical direction between the two magnets 321 and 322 and the electromagnetic wave irradiation device 30 can be adjusted. The two magnets 321 and 322 are arranged in such a way that there are provided “an N-pole, an S-pole, an N-pole, and an S-pole” from the top. The magnets 321 and 322 can be configured simply by superposing two ring-shaped magnets one upon another.

The measuring instrument 300 A shown in FIG. 9 and the measuring instrument 30.0 B shown in FIG. 10 differ from each other only in that the former uses two magnets 321 and 322, while the latter using four ring-shaped magnets 321, 322, 323, and 324, and except for the number of magnets used, they have the same configuration. In the configuration shown in FIG. 10, the four magnets 321, 322, 323, and 324 are arranged in such a way that there are provided “an N-pole, an S-pole, an N-pole, an S-pole, an N-pole, an S-pole, an N-pole, and an S-pole” from the top. Also in this case, the magnets 321, 322, 323, and 324 can be configured simply by superposing four ring-shaped magnets one upon another.

Next, the main components of the measuring instruments 300A and 300B will be explained in detail. The magnets 321 and 322 are formed of two ring-shaped magnets. The specific dimensions of each magnet are 90 mm in outside diameter, 50 mm in inside diameter, and 16 mm in thickness. Likewise, the magnets 323 and 324 are ring-shaped magnets, and the specific dimensions of each magnet are 90 mm in outside diameter, 50 mm in inside diameter, and 16 mm in thickness.

The electromagnetic wave irradiation device 30 is the same device as described above, using a 32-lamp type black light to irradiate ultraviolet light. The electromagnetic wave irradiation device power supply 40 and controller 50 shown in FIG. 9 and FIG. 10 is also the same as described above, being provided with three size-D batteries for operating the 32-lamp type black light, and a switch. According to the on-off control of this switch, the on-off operation of electromagnetic wave irradiation from the electromagnetic wave irradiation device is performed. In addition, the electromagnetic wave irradiation device wiring 41 is formed of an electric wire with very small diameter for communications.

<Points of Attention That Was Paid in Making Measurement>

Prior to describing the setup for measurement and the steps for measurement operation using the measuring instruments 300, 300A, and 300B (hereinafter, to be abbreviated to the “measuring instrument 300, and the like”), the points of attention that was paid in performing a measurement will be described. In performing a measurement, regardless of whether the measuring instrument 300 with the electromagnetic coil 310 shown in FIG. 6, the measuring instruments 300A with the magnets 321 and 322 shown in FIG. 9 (hereinafter, the magnets 321 and 322 to be abbreviated to “the magnet 321, and the like”), or the measuring instruments 300B with the magnets 321, 322, 323, and 324 shown in FIG. 10 (hereinafter, the magnets 321, 322, 323, and 324 to be abbreviated to “the magnet 321, and the like”) was used, the measurement was performed, attention having been paid to the following points.

Point of attention 1: Since the influence of the terrestrial magnetism is unavoidable except in a special room, when setting the electromagnetic coil 310, or the magnet 321, and the like, being used in the measuring instrument 300, or the like, the “N-pole” must be placed on the upper side in the northern hemisphere. Contrarily, on the southern hemisphere, the “S-pole” must be placed on the upper side.

Point of attention 2: If, in the measurement place, there is a piece of equipment that may generate a magnetic field, the measuring instrument must be separated away therefrom by a distance of as 3 to 4 m. This is because the measurement is affected by an attractive force or repulsive force, having been produced by the magnetic field of the measuring instrument 300, or the like.

Point of attention 3: If, in the measurement place, there is a magnetic substance, the measuring instrument must be separated away therefrom by a distance as large as 3 to 4 m. This is because the influence of an attractive force, having been produced by the magnetism of the measuring instrument 300, or the like, makes it difficult to perform a highly accurate measurement.

Point of attention 4: Measurement must be performed in a place without winds. This is because the repulsive force of the gravitational wave that is to be detected is small, thereby the influence of a wind making it difficult to make a measurement.

Point of attention 5: The electromagnetic wave irradiation device 30 must be positioned such that the irradiation point of the electromagnetic wave is at the center or in a vicinity of the center of the magnetic field. This is because, in both the measurement with the electromagnetic coil 310 shown in FIG. 6 and the measurement with the magnet 321, and the like, shown in FIG. 9 and FIG. 10, in case where the irradiation point of the electromagnetic wave is located at the center of the measuring magnetic field, a maximum force of repulsion to the gravitational wave is generated.

Point of attention 6: The current consumption by the electromagnetic wave irradiation device 30 is unexpectedly large, and therefore three new D-sized batteries must be used for measurement. In the measurement, having been performed, the initial energizing electric current was 880 mA. Thereafter, the electric current was gradually reduced, and in the vicinity of 600 mA, it was so reduced that measuring the force of repulsion to the gravitational wave was impossible. Supplying of power to the electromagnetic wave irradiation device 30 must be controlled on the basis of the supplied current rather than on the supplied voltage. In other words, measurement must be performed while taking care of the value indicated by the ammeter.

Point of attention 7: Electrical wiring must be performed by using a method with which the wiring resistance can be held to a minimum.

Point of attention 8: When the measurement is to be performed by using both of the electromagnetic coil 310 shown in FIG. 6 and the magnet 321, and the like, shown in FIG. 9 or FIG. 10, the measurement must be started from the measurement with the electromagnetic coil 310. By energizing the electromagnetic coil 310, it is made possible to measure the degree of the influences as mentioned in the above Points of attention 1, 2, and 3.

Point of attention 9: It must be noted that, since the present measuring instrument 300, and the like, are for an extremely small scale of experiment, and particularly they do not use an optimum electromagnetic wave, the force of repulsion to the gravitational wave that is to be measured is of an extremely small amount.

<Setup for Measurement, and Steps for Measuring Operation>

### <<Setup for Measurement>>

To the hanging metal fitting 213 of the balance arm 204 in the balance 200 shown in FIG. 5, a stone weight is fixed. On the other hand, to the hanging metal fitting 212 of the balance arm 204, the measuring instrument 300 with the electromagnetic coil 310 shown in FIG. 6, or the measuring instrument 300A or 300B with the magnet 321, and the like, shown in FIG. 9 or FIG. 10, respectively, which is to be repulsed by the gravitational wave, is fixed. If both the measurement with the electromagnetic coil 310 shown in FIG. 6 and the measurement with the magnet 321, and the like, are to be performed, it is desirable that the measuring instrument 300 with the electromagnetic coil 310 be used first for measurement. At this time, check must be made to be sure that the requirements as given in the above Points of attention 1, 2, and 3 are met.

<<Steps for Measuring Operation>>

Step 1: First, in a non-current carrying state, while confirming the position of the pointer 207 of the balance 200 on the scale, the measuring instrument 300 in FIG. 6, the measuring instrument 300A in FIG. 9, or the measuring instrument 300B in FIG. 10 is balanced with the weight. The positions of the measuring instrument 300 in FIG. 6, the measuring instrument 300A in FIG. 9, or the measuring instrument 300B in FIG. 10 are kept fixed. In FIG. 5, the weight suspension part 211 is moved to strike a balance between the balance arms 204. The oscillation of the pointer 207 is stopped at the middle point of the graduations in FIG. 5. In order to finally stop the oscillation of the pointer 207, a coin (preferably a 1-yen coin), for example, is moved on the balance arm 204 in an appropriate manner.

Step 2: In case where the measuring instrument 300 with the electromagnetic coil 310 shown in FIG. 6 is used, when the operation at Step 1 has been completed, an electric current is caused to flow from the electromagnetic coil power supply 312 to the electromagnetic coil 310 in FIG. 6. The flow of such electric current will cause the pointer 207 to be deflected under the influence as mentioned in the above Points of attention 1, 2, and 3. The position of the pointer after having been deflected is matched to the middle point of the graduations. If the deflection of the pointer 207 has exceeded 0.3 mm, the location for measurement is shifted to another one.

Step 3: Then, the measurement operation is started after the oscillation of the pointer 207 having been stopped. In case where the measuring instrument 300 with the electromagnetic coil 310 shown in FIG. 6 is used, either of the electromagnetic coil 310 or the electromagnetic wave irradiation device 30 may be first energized, or both may be energized simultaneously. Measurement using the measuring instrument 300 with the electromagnetic coil 310 must be carried out with care being taken not to cause the electromagnetic coil 310 to be overheated. When the measuring instrument 300A or 300B with the magnet 321, and the like, shown in FIG. 9 or FIG. 10, respectively, is used for making a measurement, after the oscillation of the pointer 207 having been stopped, the electromagnetic wave irradiation device 30 shown in FIG. 9 or FIG. 10 is energized.

Step 4: As a result of the energization, the pointer is slightly deflected, and thus careful observation is required. In a measurement, having been made using the measuring instrument 300 with the electromagnetic coil 310 shown in FIG. 6, an estimated amount of “loss in weight” of 3 to 4 mg was given. In making a measurement, when the pointer 207 is at an extreme right position, the electromagnetic wave irradiation device 30 is caused to start its operation, while when the pointer 207 is at an extreme left position, the electromagnetic wave irradiation device 30 is caused to stop its operation. By repeating this, the loss in weight can be grasped. Further, the position of the electromagnetic wave irradiation device 30 can have a subtle effect on the measurement, thus frequent adjustment thereof being required.

<Results of Measurement>

The measurements, having been made using the measuring instrument 300A or 300B with the magnet 321, and the like, shown in FIG. 9 or FIG. 10, respectively, exhibited an estimated amount of loss in weight of 5 to 7 mg when ultraviolet light was irradiated from the electromagnetic wave irradiation device 30 to a vicinity of the center of the magnet 321, and the like. When the number of magnets was one, no loss in weight was detected, and the number of magnets was four, the total mass of the magnets 321, and the like, and the weight was too large to obtain an estimated value of loss in weight.

<Matters to be Considered>

With the method which was used in the Example at this time, superposing the magnet 321, and the like, upon one another for making a measurement, the state of magnetic field within the columnar magnet 321, and the like, is unclear, and there is a possibility that the same magnetic field as expected at the beginning could not have been generated. In future, it is desirable to conduct an experiment using a powerful magnetic field, and a variety of electromagnetic waves in a single columnar magnetic field.

<Conclusion>

As described above, by generating a magnetic field using the columnar magnet 321, and the like, or the electromagnetic coil 310 (the magnetic field generation part), and causing the electromagnetic wave irradiation part 31 to irradiate an electromagnetic wave in parallel or substantially in parallel with the gravitational wave at the center or in a vicinity of the magnetic field, having been generated, it is possible to obtain power repulsive to the gravitational force.

As a result of this, it is possible to realize a power generating apparatus 10, which offers a variety of advantages, such as being small-sized, energy saving, and ecology friendly. Further, it is made possible to realize a variety of mobile bodies 100 and 110, which are moved with power, being generated by the power generating apparatus 10 of the present invention.

<Variant 1>

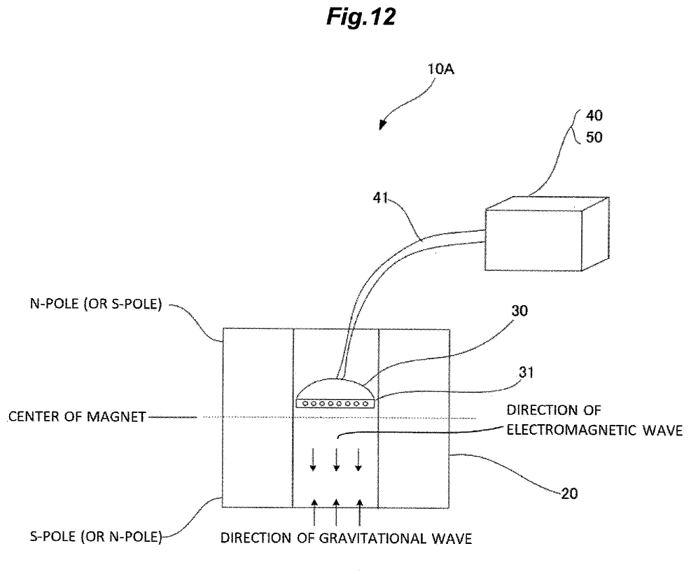

As a variant 1 of the above-described power generating apparatus 10, a power generating apparatus 10A as stated below can be considered. As shown in FIG. 12, the basic configuration of the power generating apparatus 10A is the same as that of the power generating apparatus 10, however, with the power generating apparatus 10A, the position where the electromagnetic wave irradiation device 30 is disposed in the hollow portion of the columnar magnet 20 is displaced to slightly above the middle in a vertical direction.

In this way, by raising the position of the electromagnetic wave irradiation part 31 upward, the gravitational wave from under in FIG. 12 is deformed by the S-pole in the magnetic field of the columnar magnet 20. On the other hand, the electromagnetic wave, having been emitted from the electromagnetic wave irradiation part 31 is deformed by the N-pole. Thereby, the gravitational wave, having been deformed by the S-pole, and the electromagnetic wave, having been deformed by the N-pole, will produce a phenomenon of attraction in the central portion of the magnetic field.

<Variant 2>

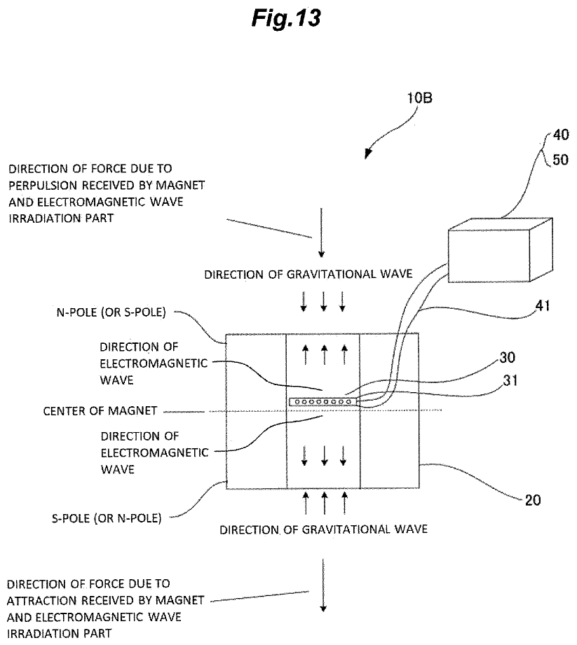

In addition, as a variant 2 of the above-described power generating apparatus 10, a power generating apparatus 10B as stated below can be considered. As shown in FIG. 13, the basic configuration of the power generating apparatus 10B is the same as that of the power generating apparatus 10, however, with the power generating apparatus 10B, a cover and reflection plate above the electromagnetic wave irradiation part 31 (see FIG. 1), which is provided for the power generating apparatus 10, is eliminated.

Thereby, the electromagnetic wave irradiation part 31 irradiates an electromagnetic wave both in a downward direction and an upward direction in FIG. 13 with respect to the magnetic field. With such a structure, an attractive force and a repulsive force can be obtained simultaneously. Since the gravitational wave arrives at the magnet from every spatial direction, it can be considered that the power generating apparatus 10B is effective especially when used in the outer space.

Heretofore, the embodiments of the present invention have been described with reference to the drawings, however, the specific configuration is not limited to that of these embodiments as described above, and various changes and modifications may be included in the present invention, so long as they do not depart from the spirit and scope thereof. Each of the power generating apparatus 10 related to the above-described embodiments, the power generating apparatus 10A related to the variant 1, and the power generating apparatus 10B related to the variant 2 may be used with an appropriate alteration being provided therefor.

For example, the geometry of the magnet 321, and the like, is not limited to a columnar shape, and an object around which the coil is to be wound is not limited to a cylindrical one, but may be a hollow non-magnetic material having an n-polygonal cross-section (where n is an integral number). In addition, various parameters, such as the length of the magnet 321, and the like, the number of magnets of the magnet 321, and the like, the number of turns of the coil, and the length of the coil, may be appropriately altered.

Further, the electromagnetic wave, being irradiated by the electromagnetic wave irradiation part 31, is not limited to “light”, such as ultraviolet light, infrared light, and visible light, and may be an “electric wave”, such as a microwave, and a millimetric wave. In this case, the electromagnetic wave irradiation part 31 may be configured to oscillate an electromagnetic wave with the use of a magnetron, a GUNN diode, or the like.

### INDUSTRIAL APPLICABILITY

The present invention can be widely utilized for a variety of power generating apparatuses. In addition, by using a plurality of power generating apparatuses, a large-sized mobile body can be created.

What is claimed is:

1. A power generating apparatus for obtaining a force to repulse the gravitational force, comprising:
a magnetic field generation part, generating a magnetic field, and
an electromagnetic wave irradiation part, irradiating an electromagnetic wave on a gravitational wave within said magnetic field, having been generated.

2. The power generating apparatus according to claim 1, wherein said electromagnetic wave irradiation part irradiates the electromagnetic wave in parallel or substantially in parallel with said gravitational wave at the center or in a vicinity of the center of the magnetic field, having been generated by said magnetic field generation part.

3. The power generating apparatus according to claim 1, wherein said magnetic field generation part generates a magnetic field upon an electric current being caused to flow through a coil, being foimed by winding an electric wire around a non-magnetic material cylindrical member.

4. The power generating apparatus according to claim 1, wherein said magnetic field generation part is formed of a cylindrical magnet.

5. The power generating apparatus according to claim 3, wherein said magnetic field generation part causes an electric current to generate a magnetic field after said coil having been brought into a superconducting state.
